(19) United States
(12) Patent Application Publication
(10) Pub. No.: US 2026/0065231 A1
(43) Pub. Date: Mar. 5, 2026

(54) GAMIFICATION FOR IMPROVING COMPUTER-BASED TIME MANAGEMENT

(71) Applicants: Justin Ronald Chambers, Morgantown, WV (US); Ephraim Pittore-Candelario, Morgantown, WV (US)

(72) Inventors: Justin Ronald Chambers, Morgantown, WV (US); Ephraim Pittore-Candelario, Morgantown, WV (US)

(21) Appl. No.: 19/314,072

(22) Filed: Aug. 29, 2025

Related U.S. Application Data
(60) Provisional application No. 63/688,390, filed on Aug. 29, 2024.

(51) Int. Cl. G06Q 10/109; G06Q 10/0631

(52) U.S. Cl. CPC G06Q 10/109; G06Q 10/063118

(57) ABSTRACT

A method of utilizing gamification in computer-based time management, a system for performing the method, and a computer program product for performing the method, are configured to perform operations including: allocating, by a gamification time management software tool run by a computing device, a number of time units to a user for a given time period for a project; tracking, by the gamification time management software tool, how the user utilizes ones of the time units towards the project; and awarding, by the gamification time management software tool, reward units to the user based on the user utilizing the ones of the time units toward the project.

### RELATED APPLICATIONS

This application claims priority to U.S. provisional patent application No. 63/688,390, filed Aug. 29, 2024, the entirety of which is incorporated by reference herein.

### BACKGROUND

Aspects of the present invention are directed to computer-based time management. Computer-based time management involves using software tools to track, plan, and optimize how a person uses their time. These tools typically involve calendars, reminders, alerts, and to-do lists.

### SUMMARY

In accordance with various embodiments of the disclosed invention, there is a method of time management designed to enhance engagement, improve efficiencies, and boost both individual and team productivity. By integrating elements such as time units, time periods, projects, reward units, goals, rewards, statistics, and data displays, this method and associated system transform daily time management into an engaging game-like experience. This and associated system are versatile and can be applied across various departments including Legal, Accounting, Engineering, Project Management, Human Resources (HR), Customer Service, and more, fostering a competitive yet collaborative environment.

In a first aspect of the invention, there is a method of utilizing gamification in computer-based time management, the method comprising: allocating, by a gamification time management software tool run by a computing device, a number of time units to a user for a given time period for a project; tracking, by the gamification time management software tool, how the user utilizes ones of the time units towards the project; and awarding, by the gamification time management software tool, reward units to the user based on the user utilizing the ones of the time units toward the project.

In another aspect of the invention, there is a computer program product comprising one or more computer-readable storage media and program instructions stored on the one or more computer-readable storage media to perform operations comprising the method of utilizing gamification in computer-based time management.

In another aspect of the invention, there is a computer system comprising a processor set, one or more computer-readable storage media, and program instructions stored on the one or more computer-readable storage media to cause the processor set to perform operations comprising the method of utilizing gamification in computer-based time management.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing system according to an embodiment of the present invention.

FIG. 2 shows a block diagram of an exemplary implementation of the present invention.

FIG. 3 shows a flowchart of an exemplary method in accordance with aspects of the present invention.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details in more detail than is necessary for the fundamental understanding of aspects of the present invention, the description taken with the drawings making apparent to those skilled in the art how several forms of the present invention may be embodied in practice.

Aspects of the present invention relate generally to computer-based time management and, more particularly, to gamification for improving computer-based time management. Maintaining high levels of user engagement and productivity is crucial for modern businesses. Current time management tools often fail to incentivize users to engage and be proactive when tracking time and managing projects. This often leads to disengagement and inefficiencies in those tools, which is a problem in the technical field of computer-based time management.

Implementations of the present invention address this problem, and provide an improvement in the technical field of computer-based time management, by introducing a reward approach to time management and time tracking, turning time management into a rewarding and competitive experience. By incorporating gamification into computer-based time management (e.g., via a gamification time management software tool), embodiments create a dynamic and engaging method of time tracking that promotes achievement, encourages collaboration, and improves overall productivity. These results (e.g., promoting achievement, encouraging collaboration, and improving overall productivity) represent improvements in the technical field of computer-based time management. In this manner, whether in Engineering, Project Management, HR, or Customer Service, implementations of the present invention have the potential to revolutionize workplace productivity and employee satisfaction.

It should be understood that, to the extent implementations of the invention collect, store, or employ personal information provided by or obtained from individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

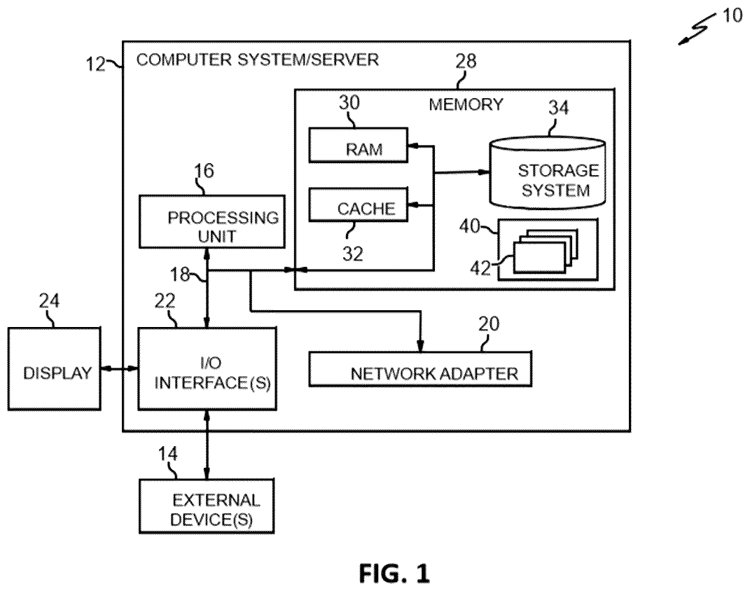

Referring now to FIG. 1, a schematic of an example of a computing environment is shown. Computing environment 10 is only one example and is not intended to suggest any limitation as to the scope of use or functionality of embodiments of the invention described herein. Regardless, computing environment 10 is capable of being implemented and/or performing any of the functionality set forth hereinabove.

In computing environment 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in computing environment 10 is shown in the form of a general-purpose computing device. The components of computer system/server 12 may include, but are not limited to, one or more processors or processing units 16 (e.g., CPUs), a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

In various embodiments, program/utility 40 comprises special-purpose code in the form of a gamification time management software tool. In these embodiments, the program modules 42 comprise modules of the gamification time management software tool. Such modules may include routines, programs, objects, components, logic, data structures, and so on that perform particular tasks or implement particular data types that the special-purpose code uses to carry out the functions and/or methodologies of embodiments of the invention as described herein. These modules of the gamification time management software tool are executable by the processing circuitry of computer system/server 12 (e.g., such as the processing unit 16) to perform the inventive methods as described herein.

In accordance with aspects of the invention, a computer (such as the computer system/server 12 of FIG. 1) that stores and runs the gamification time management software tool is a special purpose computing device. A computer (such as the computer system/server 12 of FIG. 1) that stores and runs the gamification time management software tool cannot reasonably be considered to be a generic (or general purpose) computing device since the computer that stores and runs the gamification time management software tool is specially programmed to perform functions (e.g., functions of embodiments of the invention as described herein) that are not performed by a generic computing device.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

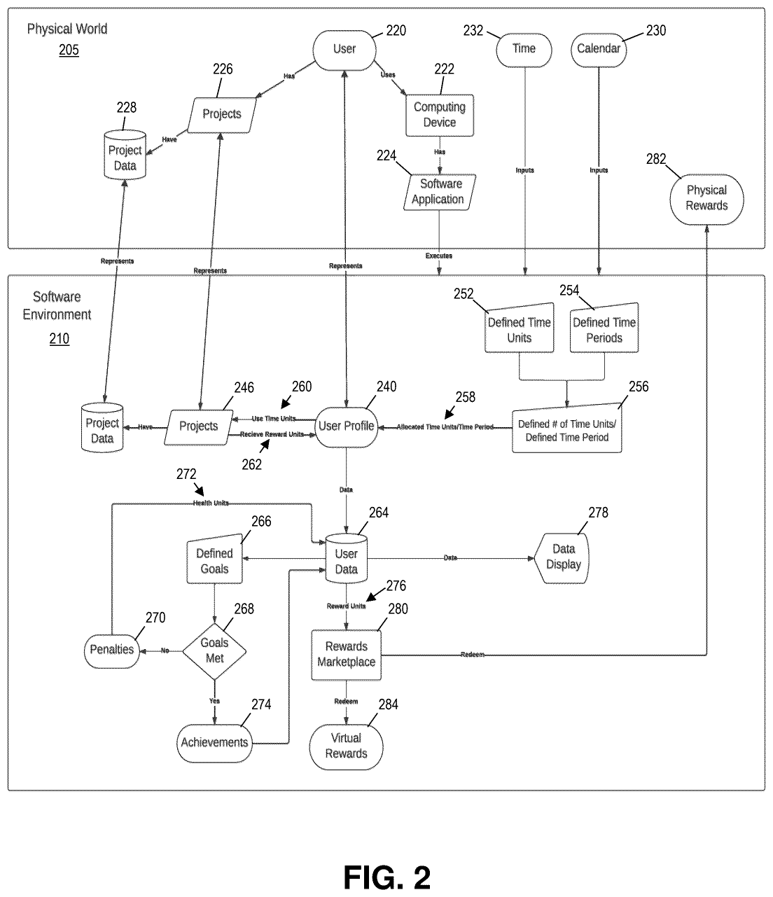

FIG. 2 shows a block diagram of an exemplary implementation of the present invention. The implementation includes a portion in the physical world 205 and a software environment 210. In embodiments, the portion in the physical world 205 includes a user 220 (e.g., a human) that utilizes a computing device 222 (e.g. computer system/server 12 of FIG. 1) that runs a software application 224 (e.g., the gamification time management software tool embodied in the program/utility 40 of FIG. 1). In this example, the user 220 has projects 226 that have project data 228. In this example, the user 220 has a calendar 230 (e.g., a computer-based calendar) and real-world time is represented by time 232. In embodiments, the software application 224 comprises the gamification time management software tool (e.g., embodied in the program/utility 40 of FIG. 1) that, when executed by the computing device 222, causes the computing device 222 to perform steps shown in the software environment 210.

In this exemplary implementation, and with continued reference to FIG. 2, the user 220, projects 226, and project data 228 in the physical world 205 are represented in the software environment 210 by a user profile 240, projects 246, and project data 248, respectively. The user profile 240, projects 246, and project data 248 may comprise data structures that contain data that define aspects of the user 220, projects 226, and project data 228, respectively. Users thus have real world projects 226 that are represented by projects 246 in the software environment and, as described herein, users receive reward units by using time units towards projects, which provides the advantageous result of encouraging efficient time management and project prioritization. Non-limiting example of projects 226 include can be any type of space, entity, item, action, task, plan, etc.

In embodiments, the software application 224 defines defined time units 252 and defined time periods 254, and uses these to define a defined number of time units per a defined number of time periods at 256. In embodiments, the software application 224 allocates time units per time period to the user at step 258. In various embodiments, the software application 224 utilizes a unique time unit based time tracking system where one time unit equates to the desired time unit selected by the administrator, e.g., one time unit is equal to one hour. In embodiments, the user is given a certain amount of time units for a given time period, e.g., one period is equal to one day. In embodiments, the time units 252 and time periods 254 are based on the real-world time 232 and calendar 230.

In embodiments, the software application 224 tracks the how the user utilizes ones of the time units 252 towards the project 246 at step 260, and at step 262 awards reward units to the user based on the user utilizing the ones of the time units 252 toward the project 246. In embodiments, the software application 224 stores data defining the allocate time units per time period, the time units used per project, and the reward units awarded to the user in a data structure represented by user data 264. The user data 264 changes as the user uses time units towards projects and receive reward units, providing a numeric representation of their progress and achievements.

In various implementations, defined goals 266 is data that represents goals that are used to set performance targets. The goals may comprise, for example, a defined number of time units that the user is expected to work on the project in a defined time period. As shown at step 268, a user loses health units via penalties 268 when the user does not achieve the defined goals 266. In this manner, the penalties 268 define the health units a user has in their profile at any particular time. Data defining the health units 272 may be stored in the user data 264. As further shown at step 268, a user is credited via achievements 274 when the user achieves the defined goals 266. Data defining the achievements may be stored in the user data 264. Achievements may be used to show streaks, levels achieved, and more.

In embodiments, the software application 224 uses reward units 276 to incentivize the user to perform good time management practices and meet goals. A user receives reward units when using time units towards projects in accordance with the goals 266. Reward units can be used to measure performance, redeem rewards and to compete with other users. In some examples, the software application 224 employs user skill profiles to remind users what activities are most valuable based on their skill profile, and this advantageously incentivizes users to utilize time units within their skill profile.

In accordance with aspects of the invention, users receive achievements 274 for reaching goals, using time units efficiently and achieving milestones. Achievement Indicators (e.g., badges, etc.) are awarded for specific achievements, adding a layer of recognition.

With continued reference to FIG. 2, the software application 224 may provide the software environment 210 with a data display 278, which may comprise a user interface (UI) having various display elements shown on the computing device 222. Multiple users can have the same project, and displaying achievements on the data display 278 promotes teamwork and fosters communication and cooperation among users. This software application 224 can aggregate other user data for displaying on the data display 278 to foster healthy competition among teams. This software application 224 can display metric-based rankings on the data display 278, which can be used and updated in real-time based on reward units earned per user, per team of users, etc. In this manner, departments can track collective progress on shared projects and goals, encouraging collaboration and a sense of shared purpose.

Reward units can be redeemed via a rewards marketplace 280 for physical rewards 282 (e.g., tangible or real-world rewards), such as gift cards, extra paid time off (PTO) days, or even promotions, adding a tangible incentive for high performance. Reward units can also be redeemed via a rewards marketplace 280 for virtual rewards 284 within the software environment 210. The software application 224 may be programmed to maintain the rewards marketplace 280, including but not limited to displaying rewards that are available, receiving user requests for redeeming their rewards for physical rewards 282 and/or virtual rewards 284, and processing the requests in accordance with one or more predefined rewards policies.

As is apparent from the description of FIG. 2, implementations of the present invention provide benefits for both users and administrators. For users, the gamified elements implemented by the software application 224 make everyday projects and tasks more enjoyable, leading to higher engagement levels. The gamification that is implemented by the software application 224 reminds and informs users on the projects that they are working on, the priority and the progress. The gamification that is implemented by the software application 224 makes reaching goals and milestones more trackable and rewarding for the users.

For administrators, by turning work into a game, the software application 224 motivates employees to be more productive, more efficient, and more competitive. The time unit based system utilized by the software application 224 ensures that time is tracked accurately to projects, allowing for better resource allocation and management. Moreover, multiuser elements enabled by the software application 224 foster teamwork and collaboration across departments, leading to more cohesive teams.

By incorporating gamification, the software application 224 creates a dynamic and engaging method of time tracking that promotes achievement, encourages collaboration, and improves overall productivity. Whether in Engineering, Project Management, HR, or Customer Service, the software application 224 has the potential to revolutionize workplace productivity and employee satisfaction.

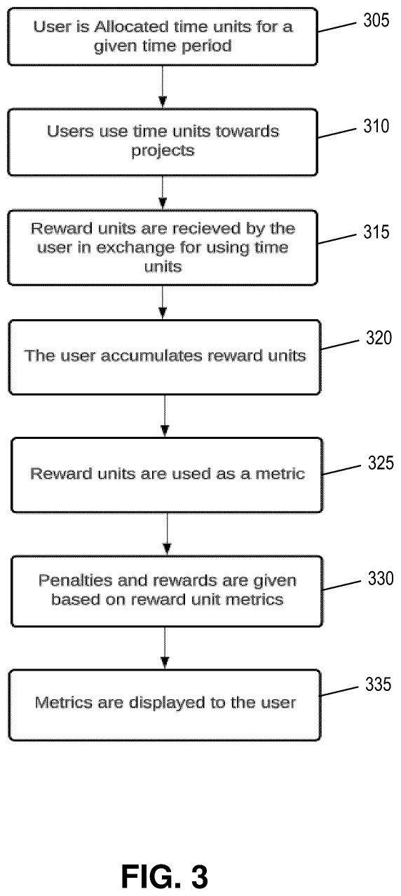

FIG. 3 shows a flowchart of an exemplary method in accordance with aspects of the present invention. One or more steps of the method (which may also be referred to as operations) may be performed by the software application 224 (i.e., the gamification time management software tool) executing in the computing device 222 as shown in FIG. 2 and are described with reference to elements depicted in FIG. 2.

At step 305 the user is allocated time units for a given time period. This may include the time units 252 and time period 254, and the time units per time period 256, being defined in the software environment by the software application 224.

At step 310 the user uses time units toward a project. This may include the user spending time working on a project 226, and the software application 224 tracking the amount of time that the user spends working on the project.

At step 315 reward units are received by the user in exchange for using time units. This may include the software application 224 awarding reward units to the user based on the user's work performed at step 310, e.g., based on the user utilizing the ones of the time units toward the project.

At step 320, the user accumulates reward units. This may include the software application 224 maintaining a count of reward units awarded to the user, e.g., at one or more instances of step 315 on one or more projects.

At step 325 the reward units are used as a metric. This may include the software application 224 analyzing the collected user data 264 to generate measurable metrics. Metrics can be any combination of measurement, mathematical or statistical interpretation of the data such as efficiencies, totals, averages, etc.

At step 330 penalties and rewards are given based on reward unit metrics. This may include the software application 224 using the user data 264 metrics to measure against defined metric goals 266 wherein if the defined metric goals 268 are met the user will receive achievements 274. If the defined metric goals 268 are not met the user will receive penalties 270.

At step 335 metrics are displayed to the user. This may include the software application 224 analyzing and utilizing the user data 264 and associated user data metrics to display the data on a data display 278 for easy visualization and interpretation. Data display can utilize any techniques known to those skilled in the art in displaying data for visualization.

It is noted that the foregoing examples have been provided merely for the purpose of explanation and are in no way to be construed as limiting of implementations of the present invention. While aspects of the present invention have been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although implementations of the present invention have been described herein with reference to particular means, materials and embodiments, implementations of the present invention are not intended to be limited to the particulars disclosed herein; rather, implementations of the present invention extend to all functionally equivalent structures, methods and uses, such as are within the scope of the appended claims.

What is claimed is:

1. A method of utilizing gamification in computer-based time management, the method comprising:
allocating, by a gamification time management software tool run by a computing device, a number of time units to a user for a given time period for use towards a project;
tracking, by the gamification time management software tool, how the user utilizes ones of the time units towards the project; and
awarding, by the gamification time management software tool, reward units to the user based on the user utilizing the ones of the time units toward the project.

2. The method of claim 1, further comprising the gamification time management software tool tracking an accumulation of reward units by the user.

3. The method of claim 1, wherein goals are defined in the gamification time management software tool based on the time units, the time periods, or the reward units.

4. The method of claim 1, further comprising:
the gamification time management software awarding an achievement to the user based on the user meeting one or more of the goals; and
the gamification time management software applying a penalty to the user based on the user missing one or more of the goals.

5. The method of claim 1, wherein the allocation of time units is defined in the gamification time management software tool to include:
time units used within a time period to which they are allocated; and
time units used outside the time period to which they are allocated.

6. The method of claim 1, further comprising the gamification time management software tool displaying user data associated with one or more users via a user interface.

7. The method of claim 1, further comprising the gamification time management software tool unlocking rewards for a user based on an amount of reward units accumulated by the user.

8. The method of claim 1, wherein the reward unit for each time unit used towards a project is determined by at least one of the following factors:
an estimated time required to complete the project;
a difficulty or complexity of the project; and
a rarity or desirability of the project.

9. The method of claim 1, further comprising:
the gamification time management software tool receiving input, from the user, requesting to redeem one or more of the reward units of the user for a predefined reward;
the gamification time management software tool processing the request and providing the predefined reward to the user.

10. The method of claim 9, wherein the predefined reward comprises one of:
a real-world reward; or
a virtual reward.

11. The method of claim 1, further comprising:
the gamification time management software tool receiving input, from the user, requesting to replenish health units of the user using one or more of achievements, redeeming virtual rewards, or waiting for a predetermined time period; and
the gamification time management software tool processing the request and replenishing the health units of the user based on the request.

12. A computer program product comprising:
one or more computer-readable storage media; and
program instructions stored on the one or more computer-readable storage media to perform operations comprising the steps of claim 1.

13. A computer system comprising:
a processing unit;
one or more computer-readable storage media; and
program instructions stored on the one or more computer-readable storage media to cause the processing unit to perform operations comprising the steps of claim 1.
